(19) United States
(12) Patent Application Publication
(10) Pub. No.: US 2009/0184509 A1
(43) Pub. Date: Jul. 23, 2009

(54) TABBED LABEL DEVICE FOR HOME OR OFFICE ORGANIZATIONAL TASKS

(76) Inventor: Adam Wolfe, Sherman Oaks, CA (US)

Correspondence Address: Adam Wolfe, 13636 Ventura blvd. #402, Sherman Oaks, CA, 91423, US

(21) Appl. No.: 12/045,877

(22) Filed: Mar. 11, 2008

Related U.S. Application Data
(60) Provisional application No. 61/011,759, filed on Jan. 22, 2008.

(51) Int. Cl. B42D 15/10

(52) U.S. Cl. 283/81

(57) ABSTRACT

A label device attachable to a structure includes a first material suitable for marking with indicia. The first material includes at least one fold to produce a first tab like structure at an angle from a plane. The first material is sufficiently flexible such that the angle can be easily changed. A second material, suitable for marking with indicia, is of similar dimensions and flexibility to the first material. The second material includes at least one fold to produce a second tab like structure at the angle. The first and second tabs are fixedly attached to one another. A base material is adhesively attached to the first and second materials along the plane to form a base for the device where the base may be attached to the structure and by changing the angle, sides of the first and second tabs can be accessed for marking with indicia.

### CROSS-REFERENCE TO RELATED APPLICATIONS

The present Utility patent application claims priority benefit of the U.S. provisional application for patent Ser. No. 61/011,759 filed on Jan. 22, 2008 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to office products. More particularly, the invention relates to a tabbed label with an adhesive back.

### BACKGROUND OF THE INVENTION

The present invention is intended to address the need for one product that performs various organizational tasks around the home or office. Currently multiple products are required in order to handle multiple organizational tasks such as, but not limited to, labeling, indexing, tabbing, making notes, etc. A single product that performs multiple tasks in one unit so that multiple products are no longer required would save time and money for consumers using the product.

In view of the foregoing, there is a need for improved techniques for providing a single item that performs multiple organizational tasks around the home or office.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary round, tabbed label, in accordance with an embodiment of the present invention;

FIG. 2 illustrates an exemplary square, tabbed label, in accordance with an embodiment of the present invention;

FIG. 3 illustrates exemplary tabbed labels wrapped around wires, in accordance with an embodiment of the present invention;

FIG. 4 illustrates exemplary tabbed labels adhered to pages of a book, in accordance with an embodiment of the present invention;

FIG. 5 illustrates an exemplary tabbed label wrapped around a file folder, in accordance with an embodiment of the present invention; and

FIG. 6 illustrates exemplary tabbed labels functioning as drafting dots, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, a tabbed label device for home or office organizational tasks is presented.

In one embodiment a label device attachable to a structure for organizational tasks is presented. The device includes a first material suitable for marking with indicia. The first material includes at least one fold to produce a tab like structure at an angle from a plane. The first material is sufficiently flexible such that the angle can be easily changed. A base material is adhesively attached to the first material along the plane to form a base for the device where the base may be attached to the structure and by changing the angle, sides of the tab can be accessed for marking with indicia. In another embodiment the first material further includes two additional folds to produce the tab. Other embodiments further include a tacky adhesive applied to a surface of the base for attaching to the structure and the tacky adhesive permits the device to be detached from the structure and reattached without damage to a surface of the structure. In various other embodiments the base material is sufficiently flexible to fold about an edge of the structure the structure includes a cylindrical shape and the base is folded about the cylindrical shape and the first and base materials are circular in shape.

In another embodiment a label device attachable to a structure for organizational tasks is presented. The device includes a first material suitable for marking with indicia. The first material includes at least one fold to produce a first tab like structure at an angle from a plane. The first material is sufficiently flexible such that the angle can be easily changed. A second material, suitable for marking with indicia, is of similar dimensions and flexibility to the first material. The second material includes at least one fold to produce a second tab like structure at the angle. The first and second tabs are fixedly attached to one another. A base material is adhesively attached to the first and second materials along the plane to form a base for the device where the base may be attached to the structure and by changing the angle, sides of the first and second tabs can be accessed for marking with indicia. Other embodiment further include a tacky adhesive applied to a surface of the base for attaching to the structure and the tacky adhesive permits the device to be detached from the structure and reattached without damage to a surface of the structure. In various other embodiments the base material is sufficiently flexible to fold about an edge of the structure, the structure includes a cylindrical shape and the base is folded about the cylindrical shape and the first and base materials are circular in shape.

In another embodiment a label device attachable to a structure for organizational tasks is presented. The device includes means for producing a tab at an angle from a plane suitable for marking with indicia and means for forming a base where the base may be attached to the structure and by changing the angle, sides of the tab can be accessed for marking with indicia. Yet another embodiment further includes means for removably attaching to the structure.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

The preferred embodiment of the present invention is intended to simplify labeling and organizational tasks around the home and office with one product. The preferred embodiment enables a user to perform various labeling, indexing and tabbing tasks by providing a tacky adhesive base and tabbed surface features. The preferred embodiment solves the need for one product that performs various organizational tasks. Current solutions only exist in the form of various products, each designed to meet one particular task. Corporations who produce office products would be interested in embodiments of the present invention as well as consumers who require organizational tools in their home, office or at school. Desired characteristics of various embodiments of the present invention include providing high functionality at various organizational tasks and features such as, but not limited to, tabbed message pads, labeling systems, index tabs, page marks, drafting dots, etc.

The preferred embodiment of the present invention combines features of multiple stationary products to provide a tabbed label with an adhesive back. The tabbed design enables the preferred embodiment to be used in various ways for example, without limitation, as a writable page mark, file folder tab, wire label, flash card, and function as an adhesive note/message pad with two areas of writable space on each side of the tab. The preferred embodiment comprises a tab placed over an adhesive-backed base.

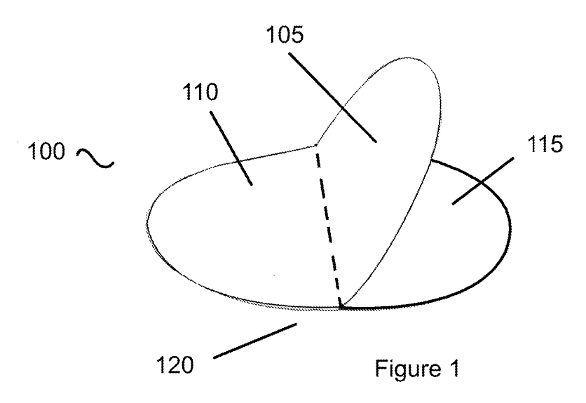

FIG. 1 illustrates an exemplary round, tabbed label 100, in accordance with an embodiment of the present invention. In the present embodiment, tabbed label 100 comprises a tab 105, created by two planes 110 and 115 of material, such as, but not limited to, paper, and a third plane forming a base 120 of the structure. The two planes 110 and 115 forming tab 105 are folded in half; the top halves of the folds are lifted, forming ninety-degree angles. The two top halves at ninety-degree angles are then adhered together. This forms the structure of tab 105, which is equal to half the length of base 120, when folded in either direction over base 120. Base 120 is then adhered to the bottom of the tabbed structure forming a secure base, linking upper planes 110 and 115 to base 120, forming one functional unit. A tacky adhesive is then applied to base 120 of tabbed label 100 in order to engage various surfaces and perform tasks. In the present embodiment base 120 is fully covered in adhesive; however, in alternate embodiments the base may also function if half covered by adhesive as opposed to being completely covered with adhesive. In the present embodiment, the adhesive on base 120 enables tabbed label 100 to be removed from and reapplied to various surfaces multiple times. However, in alternate embodiments, the adhesive may enable the tabbed label to be permanently affixed to a surface. Other alternate embodiments may have no adhesive on the base. In non-adhesive embodiments, the user may use an adhesive such as, but not limited to, glue or tape in order to affix the tabbed label to a surface if so desired.

In the present embodiment, planes 110 and 115 and base 120 are equally sized. Planes 110 and 115 are folded in half. Two halves of planes 110 and 115 are placed together forming tab 105. Base 120 is placed under the other two halves of planes 110 and 115, adhesive side down, in order to grip other surfaces. In alternate embodiments the planes creating the tabbed surface and base may not be equal in size. For example, without limitation, in an alternate embodiment, the base may be smaller than the planes creating the tabbed surface. In this embodiment the tab is larger than the base. In another alternate embodiment, the planes creating the tabbed surface are smaller than the base. In this embodiment, the tab is smaller than the base. In embodiments where the planes creating the tabbed surface and the base vary in size, the planes creating the tabbed surface are not folded in half, and instead are folded so that the lower portion of the planes correspond in size to the base. In yet other alternate embodiments the planes may be sized and folded so that the tab is not in the center of the base. In these embodiments the planes creating the tabbed surface may vary in size from each other.

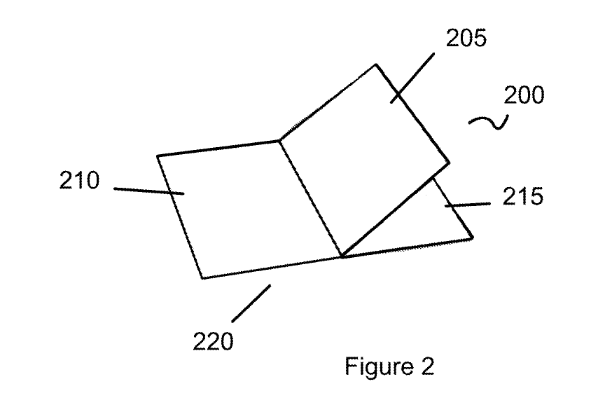

In typical use of the present invention, a user is able to write on both plane 110 and plane 115 of tabbed label 100. Therefore, when adhesive base 120 is secured on a flat surface the user is able to write on the surface of plane 110, and since the tabbed surface is three-dimensional and hinged, the user can then fold tab 105 to the other side revealing more writing surface on plane 115. In alternate embodiments the tabbed label may be any size, or any two-dimensional shape, for example, without limitation, quadrilateral, other two-dimensional geometric shapes, ovular, irregular shapes, heart-shaped, arrows, etc. A square tabbed label 200 is shown by way of example in FIG. 2. In the present embodiment, the structural planes, planes 110 and 115 and base 120, are made of paper. In alternate embodiments of the present invention other materials such as, but not limited to, various plastics, fabrics, etc. or combinations of materials may be used to achieve desired variations of tabbed labels. Furthermore various embodiments may have printing on the writing surfaces of the tabbed label, for example, without limitation, lines on which users may write, decorative designs, names, advertisements, etc.

FIG. 2 illustrates an exemplary square, tabbed label 200, in accordance with an embodiment of the present invention. In the present embodiment, tabbed label 200 comprises a tab 205, two planes 210 and 215, and a base, 220. Base 220 is coated in a tacky adhesive material enabling tabbed label 200 to be adhered to various surfaces. The components of tabbed label 200 are constructed in the same manner as tabbed label 100 shown, by way of example, in FIG. 1.

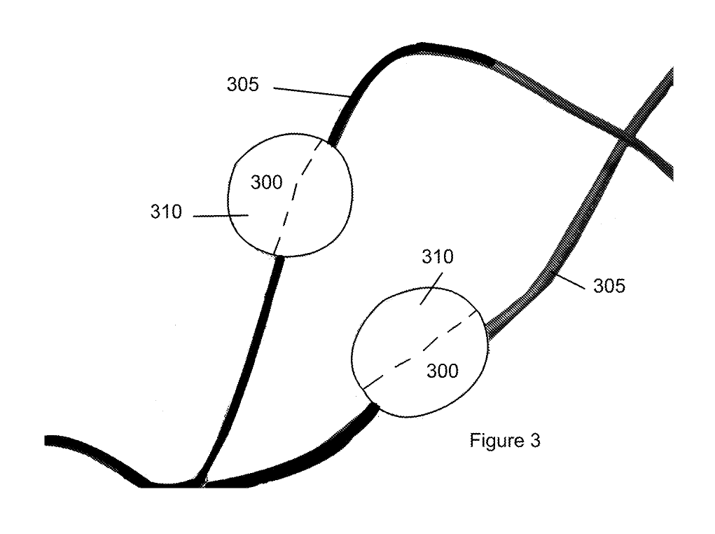

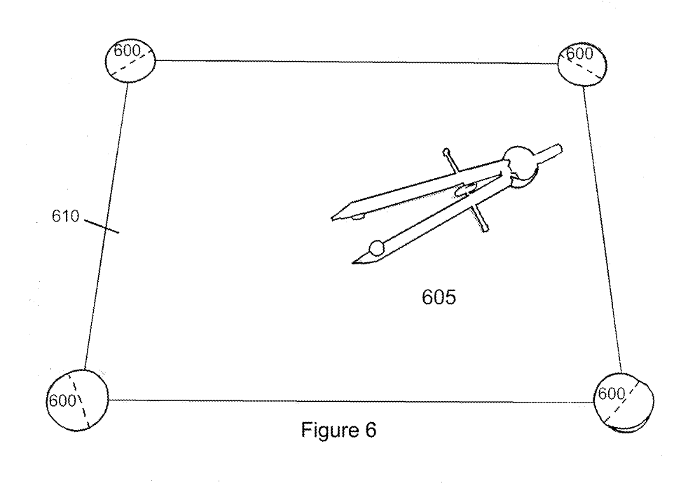

Once the components of a tabbed label are assembled, a user of the tabbed label may use the tabbed label for many intended or undiscovered purposes. In typical use of embodiments of the present invention, the tabbed design enables a user to perform multiple functions. For example, without limitation, a tabbed label according to an embodiment of the present invention is capable of wrapping around objects such as, but not limited to, wires, sheets of paper, file folders, and other objects with an edge where the adhesive base can be folded to engage two sides of the object, as shown by way of example in FIGS. 3, 4, and 5. The adhesive backing on tabbed labels according to embodiments of the present invention can also engage a flat surface, which enables a user to write messages on both planes of the tabbed surface and enables other functions such as, but not limited to, functioning as a, drafting dot, which acts by securing drafting paper to a drafting board by means of adhesive base, as shown by way of example in FIG. 6.

FIG. 3 illustrates exemplary tabbed labels 300 wrapped around wires 305, in accordance with an embodiment of the present invention. In the present embodiment, adhesive bases of tabbed labels 300 are folded around wires 305 securing tabbed labels 300 to wires 305 with tabs 310 protruding, creating a space for labeling. For example, without limitation, a user wishing to label the different wires in an audio system may write the classifications of the various wires on the tabs of tabbed labels and attach these tabbed labels to the corresponding wires.

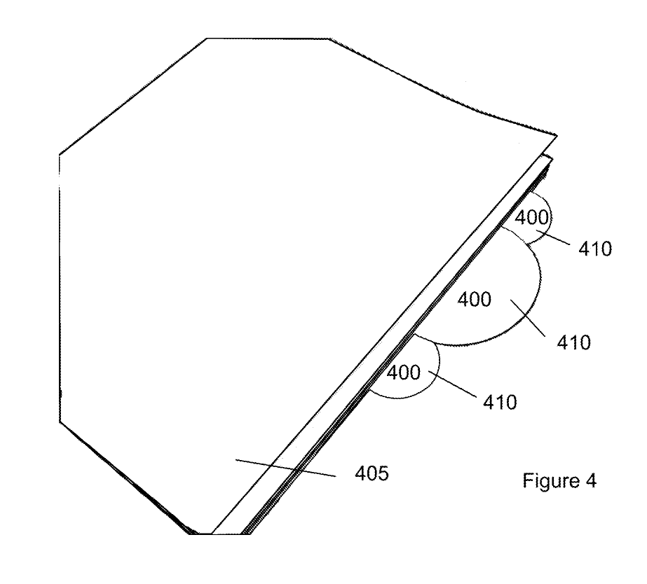

FIG. 4 illustrates exemplary tabbed labels 400 wrapped around pages of a book 405, in accordance with an embodiment of the present invention. In the present embodiment, adhesive bases of tabbed labels 400 are folded with one side of the base on the front of a page and the other side of the base secured to the back of the page. Tabs 410 protrude from the sides of the pages and facilitate notes or other markings. Marking on tabbed labels 400 generally prevent a user from marking on the pages of book 405. Tabs 410 also function as page markers. Tabbed labels according to embodiments of the present invention may be used to mark pages in other types of printed materials such as, but not limited to, magazines, newspapers, reports, etc.

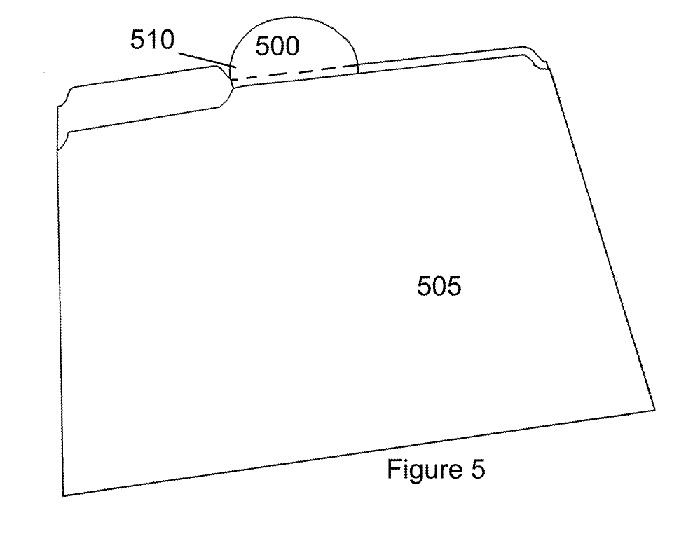

FIG. 5 illustrates an exemplary tabbed label 500 wrapped around a file folder 505, in accordance with an embodiment of the present invention. In the present embodiment, an adhesive base of tabbed label 500 engages a wall of folder 505 with a tab 510 protruding from file folder 505 for functions such as, but not limited to, labeling contents, indexing, writing notes, etc.

FIG. 6 illustrates exemplary tabbed labels 600 functioning as drafting dots, in accordance with an embodiment of the present invention. In the present embodiment, tabbed labels 600 secure drafting paper 605 to a drafting board 610 by means of adhesive bases. Furthermore, in the present embodiment the tabbed surfaces and tacky adhesive base of tabbed labels 600 allow for easy removal of tabbed labels 600 without damage to drafting paper 605 and possible reuse.

Those skilled in the art, in light of the present teachings, will recognize that tabbed labels in accordance with embodiments of the present invention may be used for various other functions. For example, without limitation, various embodiments of the present invention may be used for messages, notes, labels, etc. In some embodiments, tabbed labels may be attached together as tabbed note pads. Furthermore, some embodiments may be used for arts and crafts. Other embodiments may be used as study cards, for example, without limitation, with questions written on one side of the tab and answers on the other side of the tab.

In an alternate embodiment, a tabbed label is constructed of two planes rather than three, where the same process creates the tab as in the embodiments illustrated by way of example, in FIGS. 1 and 2; however, the present embodiment does not comprise a base plane. In this embodiment a third plane does not secure the base, and tacky adhesive is applied directly to the base of the two upper planes that form the tab.

In another alternate embodiment, a tabbed label is constructed of two planes rather than three planes, where the top plane, forming the tab, is constructed of one plane, created by three folds in the top plane, one fold in the center and two folds equal to one quarter the length of the entire plane. The tab is created when the center fold is lifted and the corresponding segments between the quarter length folds are adhered together. The second plane is then adhered to the base and tacky adhesive applied to the bottom. In yet another alternate embodiment, a tabbed label may be constructed on a single plane by folding the plane as described in the previous embodiment and omitting a second plane on the base. In this embodiment tacky adhesive is applied directly to the underside of the tabbed surface.

Having fully described at least one embodiment of the present invention, other equivalent or alternative methods of providing tabbed labels according to the present invention will be apparent to those skilled in the art. The invention has been described above by way of illustration, and the specific embodiments disclosed are not intended to limit the invention to the particular forms disclosed. For example, without limitation, the particular implementation of the tabbed surface may vary depending upon the number of tabs included. The tabbed labels described in the foregoing were directed to implementations with one tab per tabbed label; however, similar techniques are to provide tabbed labels with multiple tabs. Implementations of the present invention with multiple tabs are contemplated as within the scope of the present invention. The invention is thus to cover all modifications, equivalents, and alternatives falling within the spirit and scope of the following claims.

What is claimed is:

1. A label device attachable to a structure for organizational tasks, the device comprising:
a first material suitable for marking with indicia, said first material comprising at least one fold to produce a tab like structure at an angle from a plane, said first material being sufficiently flexible such that said angle can be easily changed; and
a base material adhesively attached to said first material along said plane to form a base for the device where said base may be attached to the structure and by changing said angle, sides of said tab can be accessed for marking with indicia.

2. The device as recited in claim 1, wherein said first material further comprises two additional folds to produce said tab.

3. The device as recited in claim 1, further comprising a tacky adhesive applied to a surface of said base for attaching to the structure.

4. The device as recited in claim 3, wherein said tacky adhesive permits the device to be detached from the structure and reattached without damage to a surface of the structure.

5. The device as recited in claim 1, wherein said base material is sufficiently flexible to fold about an edge of the structure.

6. The device as recited in claim 1, wherein the structure comprises a cylindrical shape and said base is folded about said cylindrical shape.

7. The device as recited in claim 1, wherein said first and base materials are circular in shape.

8. A label device attachable to a structure for organizational tasks, the device comprising:
a first material suitable for marking with indicia, said first material comprising at least one fold to produce a first tab like structure at an angle from a plane, said first material being sufficiently flexible such that said angle can be easily changed;
a second material suitable for marking with indicia of similar dimensions and flexibility to said first material, said second material comprising at least one fold to produce a second tab like structure at said angle, said first and second tabs being fixedly attached to one another;
a base material adhesively attached to said first and second materials along said plane to form a base for the device where said base may be attached to the structure and by changing said angle, sides of said first and second tabs can be accessed for marking with indicia.

9. The device as recited in claim 8, further comprising a tacky adhesive applied to a surface of said base for attaching to the structure.

10. The device as recited in claim 9, wherein said tacky adhesive permits the device to be detached from the structure and reattached without damage to a surface of the structure.

11. The device as recited in claim 8, wherein said base material is sufficiently flexible to fold about an edge of the structure.

12. The device as recited in claim 8, wherein the structure comprises a cylindrical shape and said base is folded about said cylindrical shape.

13. The device as recited in claim 8, wherein said first and base materials are circular in shape.

14. A label device attachable to a structure for organizational tasks, the device comprising:
means for producing a tab at an angle from a plane suitable for marking with indicia; and
means for forming a base where said base may be attached to the structure and by changing said angle, sides of said tab can be accessed for marking with indicia.

15. The device as recited in claim 14, further comprising means for removably attaching to the structure.
